(19) United States
(12) Patent Application Publication
(10) Pub. No.: US 2011/0202218 A1
(43) Pub. Date: Aug. 18, 2011

(54) EMERGENCY NOTIFICATION SYSTEM FOR ELECTRIC VEHICLE AND METHOD FOR EMERGENCY NOTIFICATION

(75) Inventor: Yoshio YANO, Kariya-city (JP)

(73) Assignee: DENSO CORPORATION, Kariya-city (JP)

(21) Appl. No.: 12/979,451

(22) Filed: Dec. 28, 2010

(30) Foreign Application Priority Data
Feb. 15, 2010 (JP) 2010-030019
Jul. 13, 2010 (JP) 2010-158693

(51) Int. Cl. G01C 21/00; B60L 11/18

(52) U.S. Cl. 701/22

(57) ABSTRACT

A control device obtains present position information on the vehicle. A battery supplies electricity to a motor, which is for driving an electric vehicle, and the control device. A battery monitor device monitors a voltage of the battery. When the obtained voltage information on the battery becomes a minimum operable voltage, the control device transmits the obtained present position information on the vehicle directly to a portable terminal through wired communications or near field communications.

### CROSS REFERENCE TO RELATED APPLICATIONS

This application is based on and incorporates herein by reference Japanese Patent Applications No. 2010-30019 filed on Feb.15, 2010 and No. 2010-158693 filed on Jul. 13, 2010.

### FIELD OF THE INVENTION

The present invention relates to an emergency notification system for an electric vehicle, the emergency notification system configured to notify a driver of present position information on a vehicle when a battery may be drained. The present invention further relates to a method for emergency notification for an electric vehicle.

### BACKGROUND OF THE INVENTION

An automobile often runs out of fuel unexpectedly during a driving operation, In such a situation, a driver needs to give position information on a location, where the automobile is stopped, appropriately to a rescue entity and a fuel stand in order to request a rescue operation. Specifically, in this case, the driver needs to give address information and coordinate information, for example. In such a case, it is conceived that present position information of a navigation system equipped in the vehicle is significantly useful.

For example, JP-A-2002-277262 discloses an art to obtain position information on the vehicle from a navigation system and transmit the obtained position information to a server through a cellular phone in a condition where a vehicle runs out of fuel or a battery is drained. Subsequently, information on a nearby service station is obtained from the server, and the obtained information is indicated on the navigation system.

In a vehicle, such as a gasoline vehicle or a hybrid vehicle, equipped with an internal combustion engine, a navigation system is in general energized by a battery, which is different from fuel supplied to the engine. Accordingly, even when an engine runs out of fuel to result in stop of a vehicle, a navigation system can be energized by a battery and operable for a while. In this case, even after the vehicle stops since the engine runs out of fuel, a navigation system can communicate with a server or a driver can operate the navigation system to confirm present position information and the like for a while. On the other hand, an electric vehicle includes a motor, which drives the vehicle, and a navigation system being commonly energized by a battery. In such an electric vehicle, when the motor stops due to fuel drainage (battery drainage), the motor stops, and the navigation system also stops simultaneously. Therefore, in such a conventional electric vehicle, a navigation system cannot communicate with a server, and a driver cannot operate the navigation system to confirm position information and the like, after the vehicle stops due to battery drainage. In addition, the system of JP-A-2002-277262 requires a server connected with a cellular phone. Accordingly, installation and management of a server requires a large cost. In addition, the system works on a premise that a cellular phone is communicable with a server for obtaining position information and the like. Therefore, when being outside a communicative range of the cellular phone, specifically when being in, for example, a tunnel, the cellular phone cannot communicate with the server. Accordingly, the vehicle may stop due to fuel drainage while a user is incapable of obtaining present position information required for a rescue request.

### SUMMARY OF THE INVENTION

In view of the foregoing and other problems, it is an object of the present invention to produce an emergency notification system for an electric vehicle, the emergency notification system being simple and inexpensive and configured to enable a driver to securely obtain present position information on a vehicle when the vehicle and a navigation system may stop due to battery drainage. it is another object of the present invention to produce a method for emergency notification for an electric vehicle.

According to one aspect of the present invention, an emergency notification system for an electric vehicle, the emergency notification system comprises a motor configured to drive the electric vehicle. The emergency notification system further comprises a control device configured to obtain present position information on the electric vehicle and communicable with a portable terminal through wired communications or near field communications. The emergency notification system further a battery configured to supply electricity to the motor and the control device. The emergency notification system further a battery monitor device configured to monitor a voltage of the battery. The control device is communicable with the battery monitor device and configured to obtain voltage information on the battery. The control device is further configured such that, when the obtained voltage information on the battery becomes a minimum operable voltage, the control device causes transmission of the obtained present position information on the electric vehicle directly to the portable terminal through wired communications or near field communications.

According to another aspect of the present invention, a method for emergency notification for an electric vehicle, the method comprises causing a control device to obtain present position information on the electric vehicle. The method further comprises monitoring a voltage of a battery to obtain voltage information on the battery, the battery being configured to supply electricity to a motor and the control device, the motor being configured to drive the electric vehicle. The method further comprises causing the control device to transmit the obtained present position information on the electric vehicle directly to a portable terminal through wired communications or near field communications when the obtained voltage information on the battery becomes a minimum operable voltage.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a system according to a first embodiment of the present invention;

FIG. 2 is a block diagram showing an electronic configuration of a navigation device;

FIG. 3 is a flow chart showing a control operation of a control circuit according to the first embodiment;

FIG. 4 is a flow chart showing a control operation of the control circuit according to a second embodiment;

FIG. 5 is a block diagram showing an electronic configuration of a navigation device according to the second embodiment;

FIG. 6 is a flow chart showing a control operation of a control circuit according to the second embodiment;

FIG. 7 is a flow chart showing a control operation of the control circuit according to a third embodiment;

FIG. 8 is a flow chart showing a control operation of the control circuit according to a fourth embodiment;

FIG. 9 is a flow chart showing a control operation of the control circuit according to a fifth embodiment; and

FIG. 10 is a flow chart showing a control operation of the control circuit according to a sixth embodiment.

### DETAILED DESCRIPTION OF PREFERRED EMBODIMENTS

As follows, the first embodiment will be described with reference to drawings.

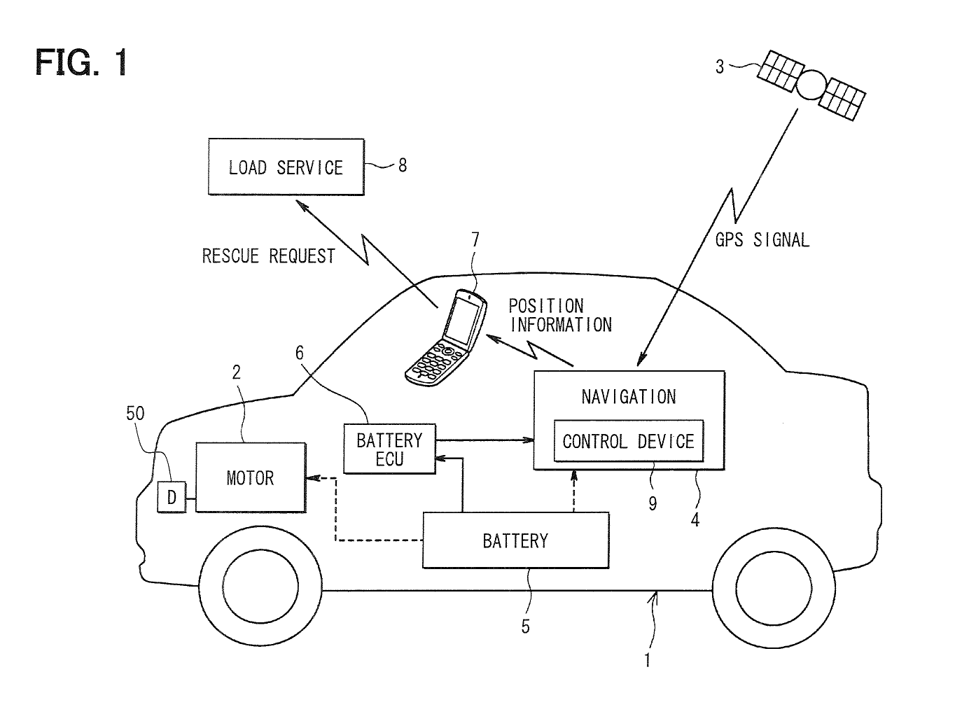

FIG. 1 is a schematic view showing an emergency notification system for an electric vehicle. The emergency notification system for an electric vehicle includes a motor 2 for driving a vehicle 1, a navigation system 4, a battery 5, and a battery management electronic control unit (ECU) 6. The navigation system 4 is configured to receive a GPS signal from a space satellite 3 for the global positioning system (GPS) and detect the position of the self-vehicle. The battery 5 includes, for example, a rechargeable battery and configured to supply electricity to the motor 2 and the navigation system 4. The battery management ECU 6 functions as a battery monitor device configured to monitor and manage the voltage of the battery 5. The navigation system 4 includes a control device 9, which will be described later. The navigation system 4 is configured to perform communications with a portable terminal 7, such as a driver's cellular phone, through a transceiver unit 17. The present communications are performed via a USB-cable connection between the devices or near field communications with, for example, Bluetooth (registered trademark).

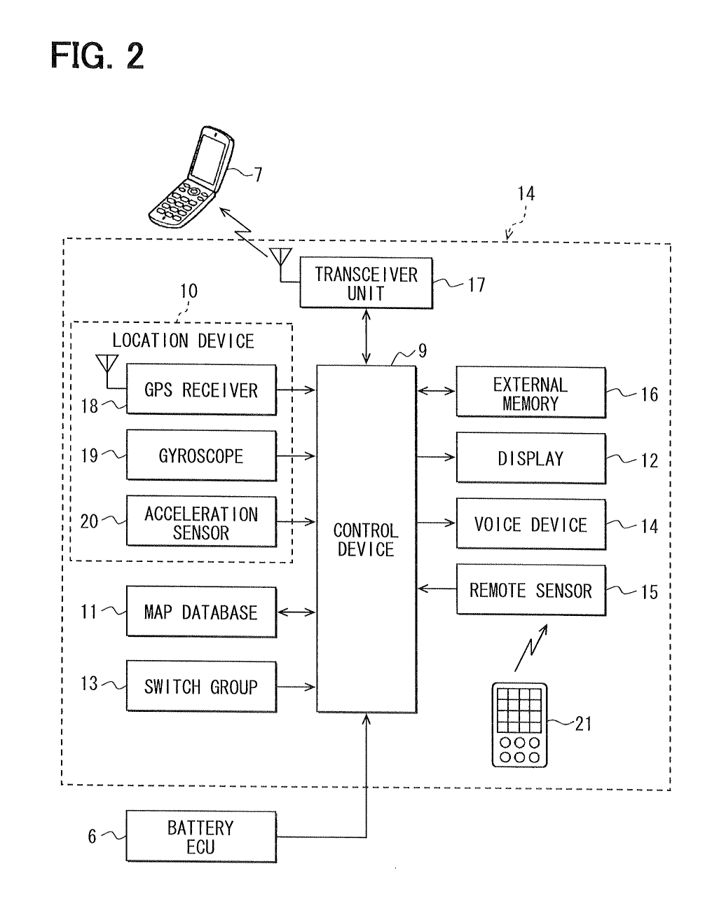

As shown in FIG. 2, the navigation system 4 includes the control device 9 for controlling a navigation operation. The control device 9 is connected with a location device 10, a map database 11, a display device 12, an operation switch group 13, a voice processing device 14, a remote controller sensor 15, an external memory 16, the transceiver unit 17, and the like.

The control device 9 includes, for example, a microcomputer including a CPU, a ROM, a RAM, an I/O interface, and a bus line, which connects these devices. The control device 9 is connected to the battery management ECU 6 and configured to confirm a remaining quantity of the battery 5 periodically on the basis of voltage information on the battery 5 transmitted from the battery management ECU 6.

The location device 10 is configured of position detection elements (location elements) such as a GPS receiver 18, a gyroscope sensor 19, and an acceleration sensor 20. The acceleration sensor 20 is for detecting an acceleration of the vehicle. The location device 10 is configured to complement detection signals of the position detection elements to detect the position of the vehicle with high accuracy. The location device 10 may be configured of a part of the detection elements in consideration of required detection accuracy. The location device 10 may further include a vehicle speed sensor for detecting a speed of the vehicle, for example.

The map database 11 is configured of a mass storage media such as a CD-ROM, a DVD-ROM, a hard disk, or a nonvolatile semiconductor memory. The map database 11 includes map image data for indicating a map image, road data required for versatile operations, such as map matching, route search, and route guidance, intersection data including detailed data of intersections, background data for a background layer, place name data for indicating a place name, and the like. The map database 11 further includes various map data such as a location database and a telephone number database The location database includes a residential area, a sparse residential area, an industrial facility area, and facility information on a hospital, a park, and a store. The telephone number database includes correspondence between a telephone number and a facility.

The display device 12 is located near a driver seat of the vehicle 1 and configured to cause indication for route guidance and the like. The operation switch group 13 includes a mechanical switch device located around the display device 12 and a touch-panel switch device located on a display unit of the display device 12. The operation switch group 13 is configured to cause an instruction command on the control device 9. The instruction command is related to operations of various kinds of data, configurations, and the like.

The voice processing device 14 is configured of a voice synthesizer circuit, an amplifier, a speaker, and the like for performing voice guidance in route guidance. The remote controller sensor 15 is configured to receive an operation signal from a remote controller 21 and provided the received operation signal to the control device 9.

The external memory 16 is configured of a nonvolatile memory, such as a flash memory, on which data is rewritable. For example, the external memory 16 is configured to store a program of software to comply with another standard of an information storage medium. The external memory 16 may be used for reading and storing specific data such as history data about a travel locus and arbitrary image data obtained by using a digital camera.

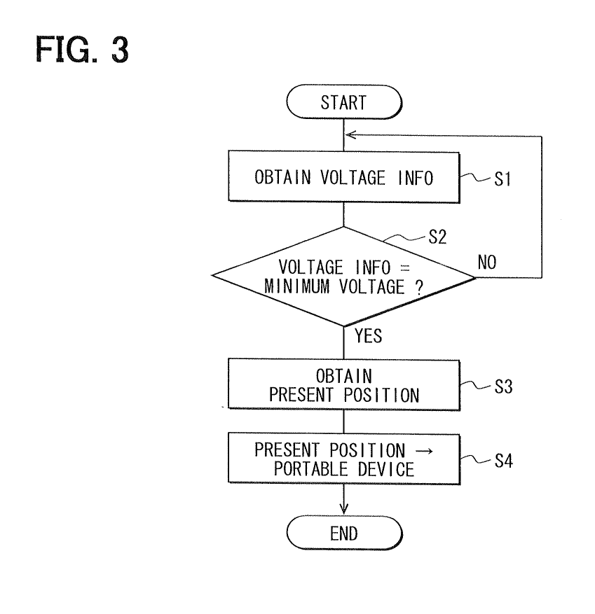

As follows, an operation of the present embodiment will be described with reference to FIG. 3. First, when a main power of the vehicle 1 is activated, electricity is supplied to the motor 2 and the navigation system 4 from the battery 5. Thus, the motor 2 and the navigation system 4 are started. Subsequently, at step S1, the control device 9 of the navigation system 4 obtains voltage information on the battery 5 from the battery management ECU 6. Subsequently, at step S2, the control device 9 compares the voltage information on the battery 5 obtained at step S1 with a predetermined minimum operable voltage. The predetermined minimum operable voltage is a voltage lower limit at which the motor 2 and the navigation system 4 are operable. When the obtained voltage information on the battery 5 is greater than the minimum operable voltage (step S2: NO), the processing returns to step S1. Normally, step S1 and step S2 are repeated when the battery is active. Thereby, the motor 2 and the navigation system 4 are in operation continuously.

In actual use, it is conceivable that a minimum operate voltage of the motor 2 differs from a minimum operable voltage of the navigation system 4. It is noted that the minimum operable voltage of the motor 2 is higher than the minimum operable voltage of the navigation system 4, in general. In consideration of this, the predetermined minimum operable voltage may be set in a range higher than the minimum operable voltage of the motor 2.

Subsequently, when the voltage of the battery 5 decreases to cause the voltage information on the battery 5 obtained at step SI to reach the minimum operable voltage at step S2 (step S2: YES), the control device 9 determines that the motor 2 and the navigation system 4 will be terminated in a specific time period due to the decrease in the voltage of the battery 5. In this case, at step S3, the control device 9 obtains present position information on the self-vehicle from the location device 10 and the map, information of the map database 11.

In reality, the voltage information on the battery ,5 varies due to aging. In consideration of this, when it is determined that the voltage information on the battery 5 is in a range of the minimum operable voltage predetermined beforehand, the processing proceeds from step S2 to step S3. In this case, it is hard to drive the motor 2 continuously with the voltage of the battery 5 when the processing proceeds from step S2 to step S3. Nevertheless, it is possible to communicate the portable terminal 7 with the control device 9 for a short time with the voltage of the battery 5 when the processing proceeds from step S2 to step S3.

Subsequently, at step S4, the control device 9 transmits the present position information directly to the portable terminal 7 connected via a cable or near field communications. The present position information includes address information, coordinate information, and the like. Subsequent to the transmission of the present position information at step S4, the motor 2 and the navigation system 4 may be terminated due to draining of the battery 5. In the present condition, a driver is enabled to send the present address of the vehicle needed for requesting a rescue operation correctly to a load service 8 (FIG. 1) according to the information on the present position of the vehicle transmitted from the control device 9 to the portable terminal 7. Thus, the driver can request a rescue operation to the load service 8 (FIG. 1).

In the present embodiment, the following operation effects can be produced. According to the configuration of the present embodiment, the battery management ECU 6 monitors the voltage of the battery 5. The battery 5 supplies electricity to the motor 2, which is for driving the vehicle 1, and the navigation system 4 including the control device 9 configured to obtain the present position information on the vehicle 1 The control device 9 is connected with the battery management ECU 6 and configured to obtain the voltage information on the battery 5. When the obtained voltage information on the battery 5 becomes the minimum operable voltage of the navigation system 4, which includes the motor 2 and the control device 9, the obtained present position information on the vehicle 1 is directly transmitted to the portable terminal 7 through a cable or near field communications. Consequently, even when the battery is drained to terminate the motor 2 and the navigation system 4, the present position information on the vehicle 1 is already transmitted to the portable terminal 7 before the termination. Therefore, the driver can obtain information needed for requesting a rescue operation after stop of the vehicle 1.

Furthermore, the control device 9 transmits the position information on the vehicle 1 directly to the portable terminal 7 without passing through another device such as a server. Therefore, the total system can be configured at low cost without installation and management cost of another device such as a server. Further, the portable terminal 7 need not communicate with a server or the like. Therefore, even when a radio wave state is not excellent when the vehicle is, for example, in a tunnel, the present position information on the vehicle 1 can be steadily obtained.

Further, when the voltage of the battery 5 becomes the minimum operable voltage, that is, immediately before termination of the motor 2 and the navigation system 4 due to drainage of the battery, the control device 9 transmits the present position information on the vehicle 1 to the portable terminal 7. In this way, the driver can obtain the present position information immediately before the vehicle 1 stops due to drainage of the battery. Therefore, the driver cannot move the vehicle 1 after transmission of the present position information on the vehicle 1 to the portable terminal 7. Accordingly, there is no possibility that the present position information on the vehicle 1 transmitted to the portable terminal 7 is rendered different from the actual present position information on the vehicle 1 due to moving of the vehicle 1 by the driver after transmission of the present position information. Thus, the driver is enabled to transmit the present position information on the self-vehicle accurately to a rescue service entity.

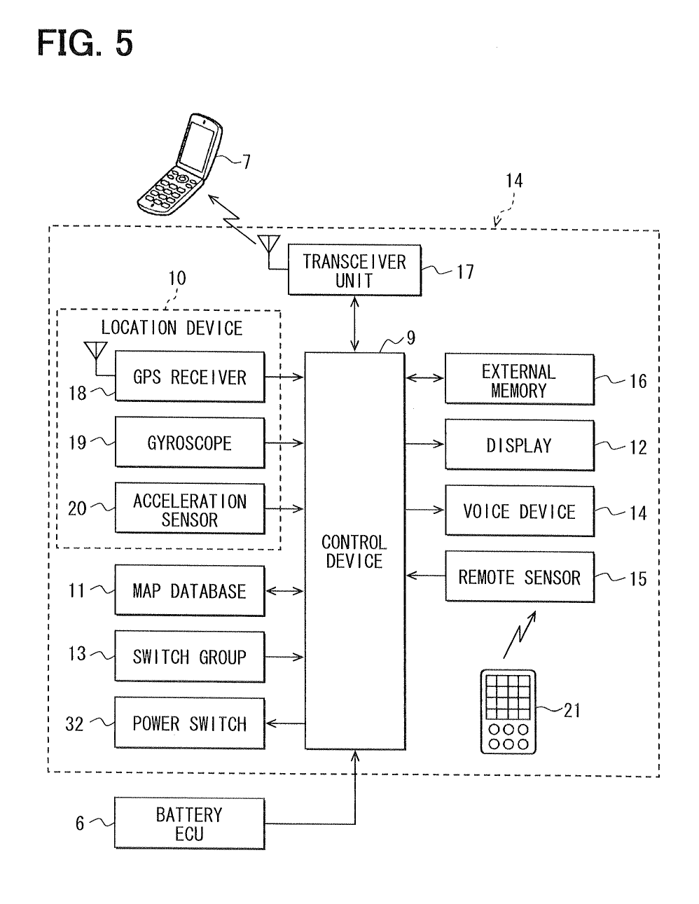

As follows, the present second embodiment will be described with reference to FIGS. 2 to 6. As follows, an identical configuration and function are denoted by reference numerals same as those in the first embodiment, and different subjects will be described mainly. In the second embodiment, an auxiliary battery 31 is further provided. The auxiliary battery 31 includes, for example, a primary battery. The auxiliary battery 31 functions as an auxiliary power source of the control device 9. In this case, the auxiliary battery 31 also functions as an auxiliary power source of the total navigation system 4 including the control device 9. The auxiliary battery 31 is equipped with an auxiliary power activation switch 32. The auxiliary power activation switch (auxiliary battery changeover switch) 32 may function as an auxiliary power activation unit including a relay switch and/or the like. The auxiliary power activation switch 32 may be, for example, a normally open switch (normally OFF). In this case, the control device 9 may control to cause the auxiliary power activation switch 32 to be closed (ON).

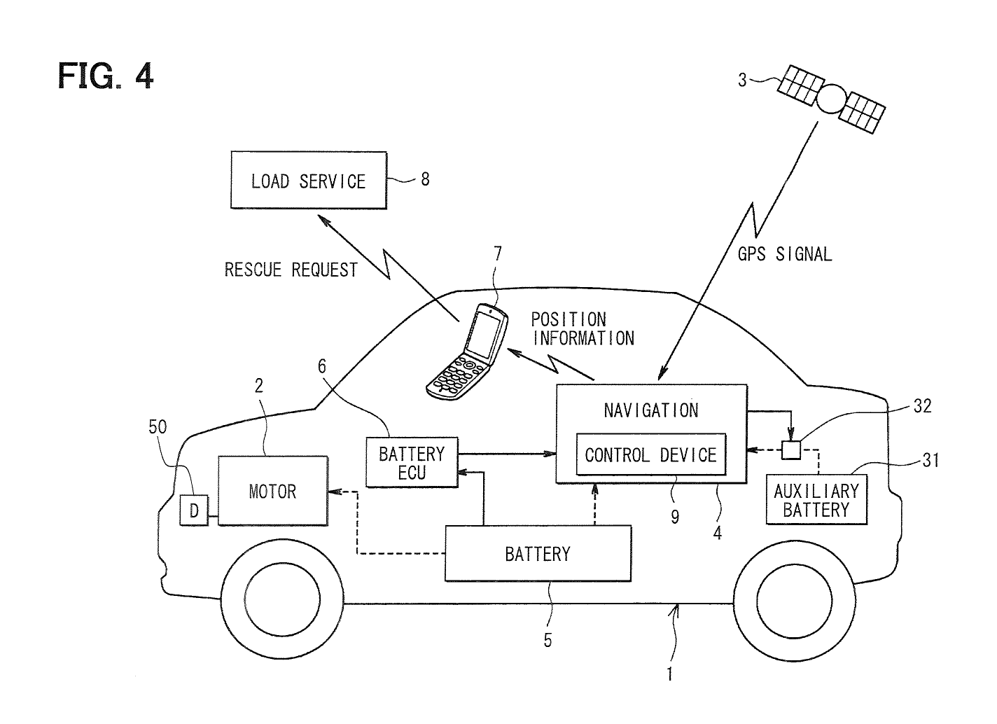

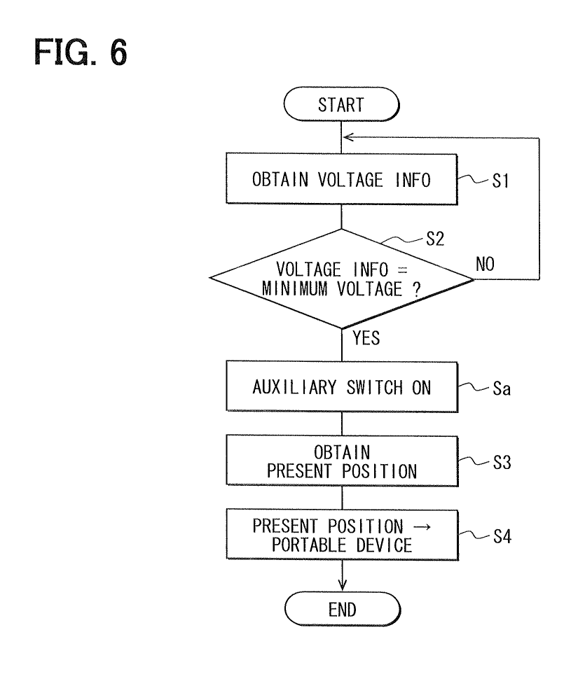

A control operation of the control device 9 will be described with reference to FIG. 6. In FIG. 6, step Sa is different from the control shown in FIG. 4 of the first embodiment. When it is determined that the obtained voltage information becomes the minimum operable voltage at step S2 (YES at step S2), the processing proceeds to step Sa at which the auxiliary power activation switch 32 is activated. Thereby, the auxiliary battery 31 is caused to supply electricity to the control device 9. Subsequently, at step S3, the present position information on the self-vehicle is obtained from the location device 10, and the map information of the map database 11 is also obtained, similarly to the first embodiment. At step S4, the present position information including the address information, the coordinate information, and the like, is directly transmitted to the portable terminal 7.

According to the second embodiment, power supply to the control device 9 can be secured by the auxiliary battery 31 (auxiliary power source) after the voltage of the battery 5 (main power source) becomes the minimum operable voltage. Therefore, transmission of the present position information from the control device 9 to the portable terminal 7 can be continued. The auxiliary power activation unit is not limited to the auxiliary power activation switch 32 configured of, for example, a relay switch device.

In the second embodiment, the minimum operable voltage may be set to a value in a constant voltage range including the minimum voltage with which the motor is rotatable. In this case, when the obtained voltage information on the battery becomes the minimum operable voltage within the constant voltage range, the control device 9 may cause the auxiliary battery 31 to supply electricity to the control device 9. Thereby, the control device 9 is enabled to transmit the present position information on the vehicle to the portable terminal 7.

Even among the same type vehicles, there is a variation among the minimum voltages, with which motors are rotatable. In consideration of this, the minimum operable voltage is set in this way. Thereby, the minimum operable voltage can be set not to cause a problem in any of vehicles in reality.

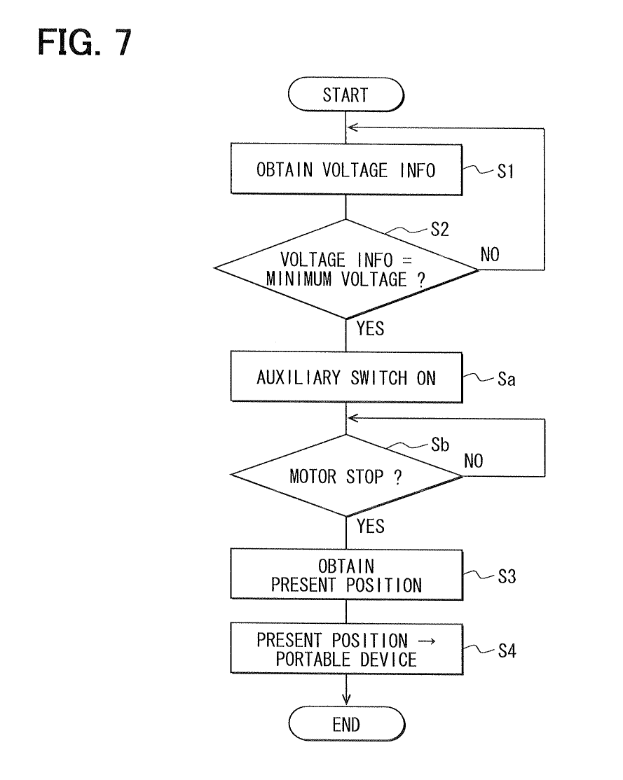

FIG. 7 is a flow chart according to the third embodiment of the present invention. In the third embodiment, the control device 9 is configured to receive a rotation signal of the motor 2. Thereby, the control device 9 also serves as a motor stop monitor unit configured to monitor stop of the motor 2 according to the rotation signal. The motor stop monitor unit may be configured of, for example, a rotation detection device other than the control device 9.

Difference between the third embodiment and the second embodiment is step Sb added to the flowchart in FIG. 6 of the second embodiment. Specifically, at step S2, when the voltage information becomes the minimum operable voltage, the processing proceeds to step Sa. At step Sa, the auxiliary power activation switch 32 is activated to supply electricity from the auxiliary battery 31 to the control device 9. Subsequently, at step Sb, it is determined whether the motor 2 stops. On determination that the motor 2 stops, at step S3, the present position information on the self-vehicle is obtained in the above-described manner. Subsequently, at step S4, the present position information including the address information, the coordinate information, and the like is directly transmitted to the portable terminal 7.

According to the present third embodiment, the present position information is transmitted to the portable terminal 7 when the motor 2 stops. Therefore, deviation between the actual stop position of the vehicle 1 and the vehicle position included in the present position information transmitted to the portable terminal can be substantially eliminated. Further, according to the third embodiment, when the voltage of the battery 5 (main power source) becomes the minimum operable voltage, the auxiliary battery 31 (auxiliary power source) is activated subsequently. Therefore, termination of power supply to the control device 9 does not occur even momentary. Thus, operation of the control device 9 can be secured. A detection unit 50 (FIG. 1) may be provided for detecting stop of the motor 2 and for outputting a motor stop detection signal to the control device 9 when detecting stop of the motor 5.

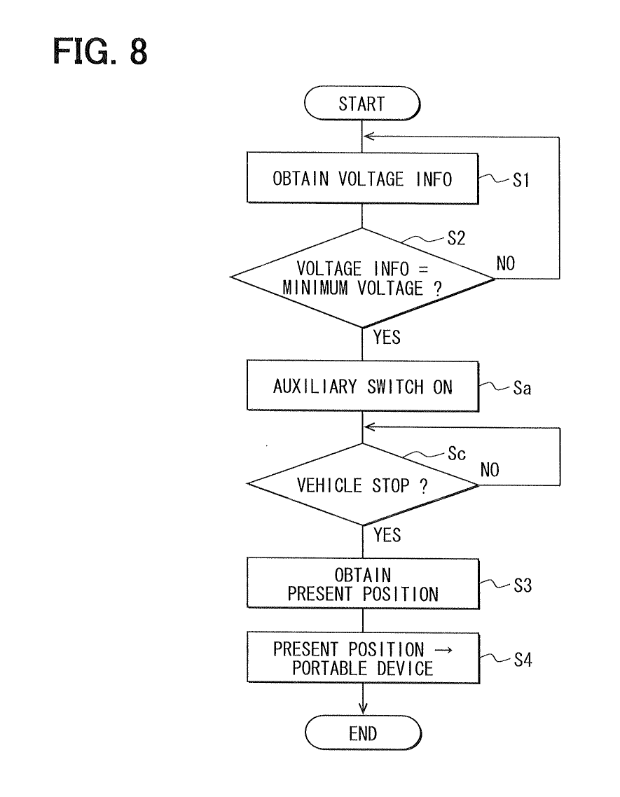

FIG. 8 is a flow chart according to the fourth embodiment of the present invention. In the fourth embodiment, the control device 9 is configured to receive a rotation signal of a wheel. Thereby, the control device 9 also serves as a vehicle stop determination unit configured to monitor stop of the vehicle 1 according to whether the control device 9 receives the rotation signal The vehicle stop determination unit may be configured of, for example, a vehicle stop determination device other than the control device 9.

FIG. 8 in the fourth embodiment differs from the third embodiment in FIG. 7 in the following subjects. Specifically, at step S2, when the voltage information becomes the minimum operable voltage, the processing proceeds to step Sa. At step Sa, the auxiliary power activation switch 32 is activated to supply electricity from the auxiliary battery 31 to the control device 9. Subsequently, at step Sc, it is determined whether the vehicle 1 stops. On determination that the vehicle 1 stops, at step S3, the present position information on the self-vehicle is obtained. Subsequently, at step S4, the present position information including the address information, the coordinate information, and the like is directly transmitted to the portable terminal 7.

According to the present fourth embodiment, the present position information on the portable terminal 7 is transmitted when the vehicle 1 stops. Therefore, deviation between the actual stop position of the vehicle 1 and the vehicle position included in the present position information transmitted to the portable terminal is substantially completely eliminated. It is noted that, in a case where the present position information is transmitted on determination that the motor 2 stops rotation, a wheel of the vehicle 1 may rotate through inertia from the rotation stop of the motor 2, and the vehicle 1 may further move consequently. In this case, the actual vehicle stop position may deviate slightly from the transmitted present position information. Nevertheless, according to the fourth embodiment, the present position information is transmitted on actual stop of the vehicle 1, as described above. Therefore, there is substantially no deviation between both the positions. Further, according to the fourth embodiment, when the voltage of the battery 5 (main power source) becomes the minimum operable voltage, the auxiliary battery 31 (auxiliary power source) is activated subsequently, similarly to the third embodiment. Therefore, termination of power supply to the control device 9 does not occur even momentary. Thus, operation of the control device 9 can be secured.

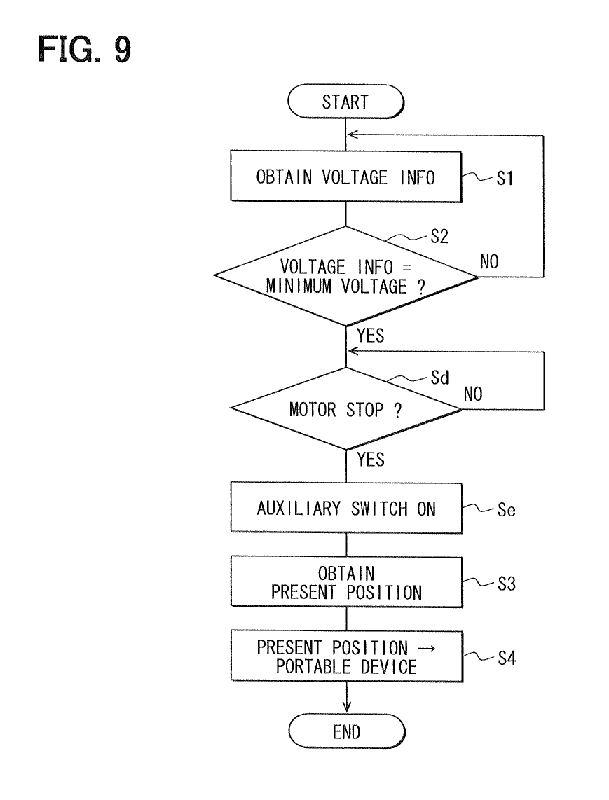

FIG. 9 is a flow chart according to the fifth embodiment of the present invention. The fifth embodiment differs from the third embodiment in FIG. 7 in the following subjects. Specifically, at step S2, when the voltage information becomes the minimum operable voltage, the processing proceeds to step Sd. At step Sd, it is determined whether the motor 2 stops. On determination that the motor 2 stops, at step Se, the auxiliary power activation switch 32 is activated to supply electricity from the auxiliary battery 31 to the control device 9. At step S3, the present position information on the self-vehicle is obtained. Subsequently, at step S4, the present position information is transmitted to the portable terminal 7.

According to a fifth the embodiment, on determination that the motor 2 stops after the voltage of the battery 5 becomes the minimum operable voltage, electricity is supplied from the auxiliary battery 31 to the control device 9. Therefore, the voltage, which the auxiliary battery 31 bears, can be further reduced. Specifically, when the remaining capacity of the battery 5 decreases, the voltage, of the battery 5 decreases through the minimum operable voltage first and decreases though the voltage at which the motor 2 actually stops. In this case, use of the auxiliary battery 31 as a power source of the control device 9 is started in the condition where the voltage of the battery 5 becomes the voltage at which the motor 2 actually stops. Therefore, it suffices that the auxiliary battery 31 secures the voltage when the use of the auxiliary battery 31 is started, i.e., when the voltage of the battery 5 becomes the voltage at which the motor 2 actually stops. Accordingly, the voltage (rating voltage) secured by the auxiliary battery 31 can be reduced, compared with a case where use of the auxiliary battery 31 as a power source of the control device 9 is started in the condition where the voltage information becomes the minimum operable voltage. As a result, the auxiliary battery 31 can be downsized. Furthermore, the total device can be restricted from being enlarged, complicated, and massive.

In general, it is supposed that the auxiliary battery 31 is used in an emergency condition and configured of a primary battery in many cases. In consideration of this, it is required that the auxiliary battery 31 has a low rating voltage and a small body as much as possible. The present embodiment satisfies such a requirement

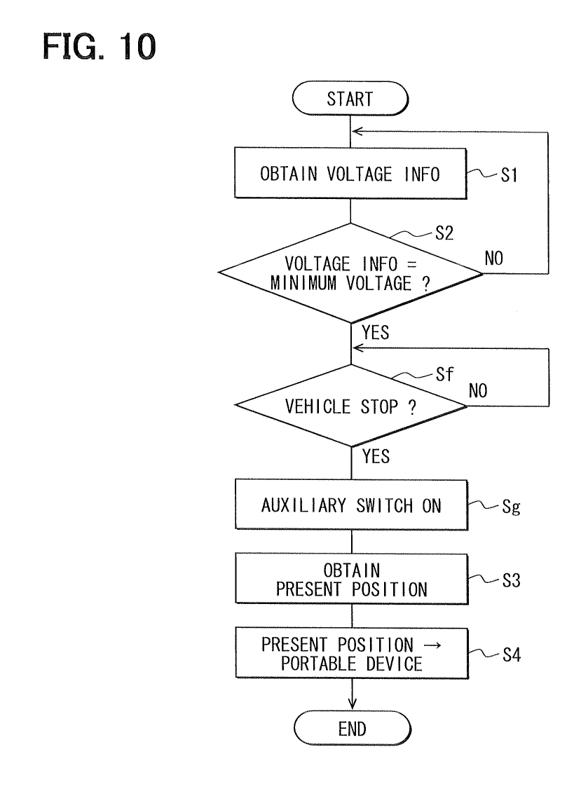

FIG. 10 is a flow chart according to the sixth embodiment of the present invention. FIG. 10 in the sixth embodiment differs from the fourth embodiment in FIG. 8 in the following subjects. Specifically, at step S2, when the voltage information becomes the minimum operable voltage, the processing proceeds to step Sf. At step Sf, it is determined whether the vehicle 1 stops. On determination that the vehicle 1 stops, at step Sg, the auxiliary power activation switch 32 is activated to supply electricity from the auxiliary battery 31 to the control device 9. At step S3, the present position information on the self-vehicle is obtained. Subsequently, at step S4, the present position information is transmitted to the portable terminal 7.

According to a sixth the embodiment, voltage secured by the auxiliary battery 31 can be further decreased. As follows, details of the present embodiment will be described. As described above, when the remaining capacity of the battery decreases, the voltage of the battery 5 decreases through the minimum operable voltage first and decreases though the voltage at which the motor 2 actually stops. In this case, a time lag may exist after the motor 2 stops before the vehicle 1 stops. Therefore, the voltage of the battery 5 may further decrease when stop of the vehicle 1 is detected.

According to the present embodiment, use of the auxiliary battery 31 as a power source of the control device 9 is started on detection of stop of the vehicle. Therefore, it suffices that the auxiliary battery 31 secures the voltage when the use of the auxiliary battery 31 is started. Accordingly, the voltage (rating voltage) secured by the auxiliary battery 31 can be reduced, compared with a case where use of the auxiliary battery 31 as a power source of the control device 9 is started in the condition where the voltage information is the voltage at which the motor stops. As a result, the auxiliary battery 31 can be further downsized. Furthermore, the total device can be further effectively restricted from being enlarged, complicated, and massive.

In the above embodiments, the control device 9 is included in the navigation system 4. Alternatively, the control device 9 may be an external device being a separate component from the navigation system 4. The connection between the control device 9 and the portable terminal 7 is not limited to USB or Bluetooth. It suffices that the control device 9 and the portable terminal 7 are connected with each other without through a server or the like such that direct communications are enabled therebetween. The portable terminal is not limited to a cellular phone. The portable terminal may be another device such as a personal digital assistant (PDA) having a function to be connected with the control device 9 through a cable or near field communications.

Summarizing the above embodiment, a battery monitor device is configured to monitor a voltage of a battery. The battery is configured to supply electricity to a motor, which is configured to drive a vehicle, and a control device, which is configured to obtain present position information on the vehicle. The control device is connected with the battery monitor device. The control device is configured to obtain voltage information on the battery When the obtained voltage information on the battery becomes a minimum operable voltage of the motor and the control device, the obtained present position information on the vehicle is directly transmitted to the portable terminal through a cable (wired communications) or near field communications. Consequently, even when the battery is drained to result in termination of the motor and the control device, the present position information on the vehicle is already transmitted to the portable terminal before the termination. Therefore, the driver can obtain information to prepare for requesting a rescue operation after stop of the vehicle.

Furthermore, the control device transmits the present position information directly to the portable terminal without passing through another object such as a server. Therefore, the total system can be configured at low cost without installation and management cost of another object such as a server. Further, the portable terminal need not communicate with a server or the like. Therefore, even when a radio wave state is not excellent when the vehicle is, for example, in a tunnel, the present position'information can be steadily obtained.

The emergency notification system for an electric vehicle may further include an auxiliary battery for the control device. When or after the obtained voltage information on the battery becomes the minimum operable voltage, the control device may cause the auxiliary battery to supply electricity to the control device itself and transmit the present position information on the vehicle directly to the portable terminal through a cable or near field communications.

In this way, a power source for the control device can be secured (covered) by the auxiliary battery after the voltage of the battery becomes the minimum operable voltage Therefore, an operation of the control device to transmit the present position information to the portable terminal can be secured. In the emergency notification system for an electric vehicle, the minimum operable voltage is set within a constant voltage range including a minimum voltage with which the motor is rotatable. When the obtained voltage information on the battery becomes the minimum operable voltage, which is in the constant voltage range, the control device may cause the auxiliary battery to supply electricity to the control device itself and transmit the present position information on the vehicle directly to the portable terminal through a cable or near field communications.

Even among the same type vehicles, there is a variation among the minimum voltages, with which motors are rotatable. In consideration of this, the constant voltage range is applied to the minimum operable voltage. Thereby, the minimum operable voltage can be set not to cause a problem in any of vehicles in actual use.

The emergency notification system of an electric vehicle may further include a motor stop monitor unit configured to monitor (determine) stop of the motor. When the obtained voltage information on the battery becomes the minimum operable voltage, the control device may cause the auxiliary battery to supply electricity to the control device itself. When the motor stop monitor unit determines that the motor stops, the control device may transmit the present position information on the vehicle directly to the portable terminal through a cable or near field communications.

According to the present configuration, the present position information is transmitted to the portable terminal when the motor stops. Therefore, deviation between the actual stop position of the vehicle and the vehicle position included in the present position information transmitted to the portable terminal is substantially eliminated.

The emergency notification system for an electric vehicle may further include a vehicle stop determination unit configured to determine whether the vehicle stops according to rotation of a wheel. When the obtained voltage information on the battery becomes the minimum operable voltage, the control device may cause the auxiliary battery to supply electricity to the control device itself. When the vehicle stop determination unit determines that the vehicle stops, the control device may transmit the present position information on the vehicle directly to the portable terminal through a cable or near field communications.

According to the present configuration, the present position information is transmitted when the vehicle actually stops. Therefore, deviation between the actual stop position of the vehicle and the vehicle position included in the present position information transmitted to the portable terminal is substantially completely eliminated.

In the emergency notification system for an electric vehicle, when the obtained voltage information on the battery becomes the minimum operable voltage, and on receiving a motor stop detection signal, the control device may cause the auxiliary battery to supply electricity to the control device itself and transmit the present position information on the vehicle directly to the portable terminal through a cable or near field communications.

According to the present configuration, after the voltage of the battery becomes the minimum operable voltage and when the motor stop detection signal is obtained, the auxiliary battery is caused to supply electricity to the control device itself. Thereby, voltage secured by the auxiliary battery can be further decreased. Specifically, when the remaining capacity of the battery decreases, the voltage of the battery decreases through the minimum operable voltage first and further decreases though the voltage at which the motor actually stops. In this case, use of the auxiliary battery as a power source of the control device is started in the condition where the voltage of the battery becomes the voltage at which the motor actually stops. Therefore, it suffices that the auxiliary battery secures the voltage when the use of the auxiliary battery is started, i.e., when the voltage of the battery becomes the voltage at which the motor actually stops. Accordingly, the voltage (rating voltage) secured by the auxiliary battery can be reduced, compared with a case where use of the auxiliary battery as a power source of the control device is started in the condition where the voltage information becomes the minimum operable voltage. As a result, the auxiliary battery can be downsized. Furthermore, the total device can be restricted from being enlarged, complicated, and massive.

In the emergency notification system for an electric vehicle, when the obtained voltage information on the battery becomes the minimum operable voltage and when the vehicle stop determination unit determines that the vehicle stops, the control device may cause the auxiliary battery to supply electricity to the control device itself and transmit the present position information on the vehicle directly to the portable terminal through a cable or near field communications.

In this way, the voltage secured by the auxiliary battery can be further decreased. Specifically, when the remaining capacity of the battery decreases, the voltage of the battery decreases through the minimum operable voltage first and further decreases though the voltage at which the motor actually stops. In this case, a time lag may exist after the motor stops before the vehicle stops. Therefore, the voltage of the battery may further decrease when stop of the vehicle is detected. According to the present configuration, use of the auxiliary battery as a power source of the control device is started on detection of stop of the vehicle. Therefore, it suffices that the auxiliary battery secures the voltage when the use of the auxiliary battery is started. Accordingly, the voltage (rating voltage) secured by the auxiliary battery can be reduced, compared with a case where use of the auxiliary battery as a power source of the control device is started in the condition where the voltage information is the voltage at which the motor stops. As a result, the auxiliary battery can be further downsized. Furthermore, the total device can be further effectively restricted from being enlarged, complicated, and massive.

The above structures of the embodiments can be combined as appropriate. The above processings such as calculations and determinations are not limited being executed by the control device 9. The control unit may have various structures including the control device 9 shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. An emergency notification system for an electric vehicle, the emergency notification system comprising:
a motor configured to drive the electric vehicle;
a control device configured to obtain present position information on the electric vehicle and communicable with a portable terminal through wired communications or near field communications;
a battery configured to supply electricity to the motor and the control device; and
a battery monitor device configured to monitor a voltage of the battery, wherein
the control device is communicable with the battery monitor device and configured to obtain voltage information on the battery, and
the control device is further configured such that, when the obtained voltage information on the battery becomes a minimum operable voltage, the control device causes transmission of the obtained present position information on the electric vehicle directly to the portable terminal through wired communications or near field communications.

2. The emergency notification system according to claim 1, further comprising:
an auxiliary battery for the control device, wherein
the control device is further configured such that, when or after the obtained voltage information on the battery becomes the minimum operable voltage, the control device causes the auxiliary battery to supply electricity to the control device and causes transmission of the present position information on the electric vehicle directly to the portable terminal through wired communications or near field communications.

3. The emergency notification system according to claim 2, wherein
the minimum operable voltage is set within a constant voltage range including a minimum voltage with which the motor is operable, and
the control device is further configured such that, when the obtained voltage information on the battery becomes the minimum operable voltage, which is in the constant voltage range, the control device causes the auxiliary battery to supply electricity to the control device and causes transmission of the present position information on the electric vehicle directly to the portable terminal through wired communications or near field communications.

4. The emergency notification system according to claim 2, further comprising:
a motor stop monitor unit configured to monitor that the motor stops, wherein
the control device is further configured such that:
when the obtained voltage information on the battery becomes the minimum operable voltage, the control device causes the auxiliary battery to supply electricity to the control device; and
when the motor stop monitor unit determines that the motor stops, the control device causes transmission of the present position information on the electric vehicle directly to the portable terminal through wired communications or near field communications.

5. The emergency notification system according to claim 2, further comprising:
a vehicle stop determination unit configured to determine whether the electric vehicle stops according to rotation of a wheel of the electric vehicle, wherein
the control device is further configured such that:
when the obtained voltage information on the battery becomes the minimum operable voltage, the control device causes the auxiliary battery to supply electricity to the control device; and
when the vehicle stop determination unit determines that the electric vehicle stops, the control device causes transmission of the present position information on the electric vehicle directly to the portable terminal through wired communications or near field communications.

6. The emergency notification system according to claim 2, further comprising:
a motor stop monitor unit configured to monitor that the motor stops, wherein the control device is further configured such that:
when the obtained voltage information on the battery becomes the minimum operable voltage, when the motor stop monitor unit determines that the motor stops, and when receiving a motor stop detection signal, the control device causes the auxiliary battery to supply electricity to the control device and causes transmission of the present position information on the electric vehicle directly to the portable terminal through wired communications or near field communications.

7. The emergency notification system according to claim 2, further comprising:
a vehicle stop determination unit configured to determine whether the electric vehicle stops according to rotation of a wheel of the electric vehicle, wherein
the control device is further configured such that:
when the obtained voltage information on the battery becomes the minimum operable voltage and when the vehicle stop determination unit determines that the electric vehicle stops, the control device causes the auxiliary battery to supply electricity to the control device and causes transmission of the present position information on the electric vehicle directly to the portable terminal through wired communications or near field communications.

8. The emergency notification system according to claim 6, further comprising:
a detection unit configured to:
detect stop of the motor; and
output a motor stop detection signal to the control device when detecting stop of the motor.

9. A method for emergency notification for an electric vehicle, the method comprising:
causing a control device to obtain present position information on the electric vehicle;
monitoring a voltage of a battery to obtain voltage information on the battery, the battery being configured to supply electricity to a motor and the control device, the motor being configured to drive the electric vehicle; and
causing the control device to transmit the obtained present position information on the electric vehicle directly to a portable terminal through wired communications or near field communications when the obtained voltage information on the battery becomes a minimum operable voltage.

10. A computer readable medium comprising instructions executed by a computer, the instructions including the method according to claim 9.
